(19) United States
(12) Patent Application Publication
(10) Pub. No.: US 2023/0351266 A1
(43) Pub. Date: Nov. 2, 2023

(54) MACHINE LEARNING DEVICE, MACHINE LEARNING METHOD, AND NON-TRANSITORY COMPUTER-READABLE RECORDING MEDIUM HAVING EMBODIED THEREON A MACHINE LEARNING PROGRAM

(71) Applicant: JVCKENWOOD Corporation, Yokohama-shi (JP)

(72) Inventors: Yincheng YANG, Yokohama-shi (JP); Hideki TAKEHARA, Yokohama-shi (JP); Shingo KIDA, Yokohama-shi (JP)

(21) Appl. No.: 18/349,198

(22) Filed: Jul. 10, 2023

Related U.S. Application Data
(63) Continuation of application No. PCT/JP2021/045339, filed on Dec. 9, 2021.

(30) Foreign Application Priority Data
Jan. 13, 2021 (JP) 2021-003240

(51) Int. Cl. G06N 20/00

(52) U.S. Cl. CPC G06N 20/00

(57) ABSTRACT

A weight storage unit stores weights of a plurality of filters used to detect a feature of a task. A continual learning unit trains the weights of the filters in response to an input task in continual learning. A filter processing unit locks, of a plurality of filters that have learned one task, the weights of a proportion of the filters to prevent the proportion of the filters from being used to learn a further task and initializes the weights of other filters to use the other filters to learn a further task. A comparison unit compares the weights of a plurality of filters that have learned two or more tasks, extracts overlap filters having a similarity in weight over a threshold value as shared filters shared by tasks, leaves one of the overlap filters as the shared filter, and initializes the weights of filters other than the shared filter.

### CROSS REFERENCE TO RELATED APPLICATION

This application is a continuation of application No. PCT/JP2021/045339, filed on Dec. 9, 2021, and claims the benefit of priority from the prior Japanese Patent Application No.2021-003240, filed on Jan. 13, 2021, the entire content of which is incorporated herein by reference.

### BACKGROUND OF THE INVENTION

### 1. Field of the Invention

The present invention relates to machine learning technologies.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-train CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in successive learning.

Incremental learning or continual learning is proposed as a scheme to avoid catastrophic forgetting. One scheme for continual learning is PackNet.

Patent document 1 discloses a learning device configured to cause two or more learning modules to share model parameters updated by multiple learning modules.

[Patent Literature 1] JP2010-20446

The problem of catastrophic forgetting can be avoided in PackNet, which is one scheme for continual learning. In PackNet, however, the number of filters in a model is limited, and there is a problem in that filters will be saturated as new tasks are learned so that the number of tasks that can be learned is limited.

### SUMMARY OF THE INVENTION

The present disclosure addresses the issue, and a purpose thereof is to provide a machine learning technology capable of mitigating saturation of filters.

A machine learning device according to an aspect of the embodiment includes: a weight storage unit that stores weights of a plurality of filters used to detect a feature of a task; a continual learning unit that trains the weights of the plurality of filters in response to an input task in continual learning; a filter processing unit that, of a plurality of filters that have learned one task, locks the weights of a predetermined proportion of the filters to prevent the predetermined proportion of the filters from being used to learn a further task and initializes the weights of other filters to use the other filters to learn a further task; and a comparison unit that compares the weights of a plurality of filters that have learned two or more tasks and extracts overlap filters having a similarity in weight equal to or greater than a predetermined threshold value as shared filters shared by tasks.

Another aspect of the embodiment relates to a machine learning method. The method includes: training weights of a plurality of filters used to detect a feature of a task in response to an input task in continual learning; of a plurality of filters that have learned one task, locking the weights of a predetermined proportion of the filters to prevent the predetermined proportion of the filters from being used to learn a further task and initializing the weights of other filters to use the other filters to learn a further task; and comparing the weights of a plurality of filters that have learned two or more tasks, leaving one of overlap filters having a similarity in weight equal to or higher than a predetermined threshold value, and initializing the weights of other filters to use the other filters to learn a further task.

Optional combinations of the aforementioned constituting elements, and implementations of the embodiment in the form of methods, apparatuses, systems, recording mediums, and computer programs may also be practiced as additional modes of the present disclosure.

### BRIEF DESCRIPTION OF THE DRAWINGS

FIGS. 1A-1E show continual learning, which is defined as a base technology;

FIG. 2 shows a configuration of a machine learning device according to the embodiment;

FIGS. 3A-3E show continual learning performed by the machine learning device of FIG. 2;

FIG. 4 shows an operation of the comparison unit of the machine learning device of FIG. 2; and

FIG. 5 is a flowchart showing a sequence of steps of continual learning performed by the machine learning device of FIG. 2.

### DETAILED DESCRIPTION OF THE INVENTION

The invention will now be described by reference to the preferred embodiments. This does not intend to limit the scope of the present invention, but to exemplify the invention.

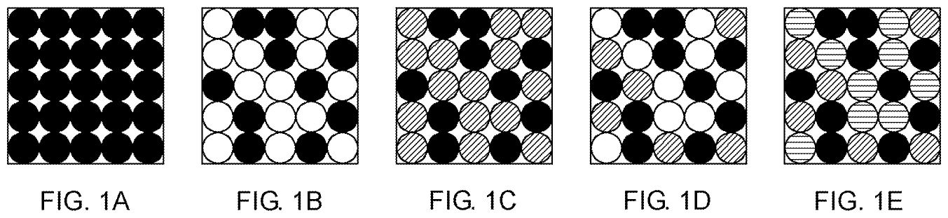

FIGS. 1A-1E show continual learning by PackNet, which is defined as a base technology. In PackNet, the weights of multiple filters in a model are trained in response to a given task. The figures show multiple filters in each layer of a convolutional neural network arranged in a lattice.

The learning process in PackNet proceeds in the following steps (A)-(E).

(A) The model learns task 1. FIG. 1A shows an initial state of the filters that have learned task 1. All filters have learned task 1 and are shown in black.

(B) The filters are arranged in the descending order of weight value of the filter. The values of 60% of the entire filters are initialized in the ascending order of weight value. FIG. 1B shows a final state of the filters that have learned task 1. The initialized filters are shown in white.

(C) Task 2 is then learned. In this step, the weight values of the black filters of FIG. 1B are locked. The weight values of only the white filters can be changed. FIG. 1C shows an initial state of the filters that have learned task 2. All filters shown in white in FIG. 1B have learned task 2 and are shown in hatched lines in FIG. 1C.

(D) As in step (B), the hatched filters that have learned task 2 are arranged in the descending order of weight value of the filter. The values of 60% of the entire filters are initialized in the ascending order weight value. FIG. 1D shows a final state of the filters that have learned task 2. The initialized filters are shown in white.

(E) Further, task 3 is learned. In this step, the weight values of the black and hatched filters of FIG. 1D are locked. The weight values of only the white filters can be changed. FIG. 1E shows an initial state of the filters that have learned task 3. All filters shown in white in FIG. 1D have learned task 3 and are shown in horizontal stripes in FIG. 1E.

As learning continues through task N in the learning process according to PackNet in this way, the number of initialized white filters will be increasingly smaller, resulting in saturation. When the filters are saturated, it will no longer be possible to learn a new task.

Saturation of the PackNet filters at some point of time cannot be avoided. However, the speed of saturation of the filters can be mitigated. The embodiment addresses the issue by extracting, every time a new task is learned, overlap filters having a high similarity in weight as shared filters shared by tasks. Of the overlap filters, one filter is left as a shared filter, and the weight of the filters other than the shared filter is initialized to 0. This makes it possible to increase filters that can be learn a new task, mitigate the speed of saturation of the filters, and increase the number of filters that can learn a task.

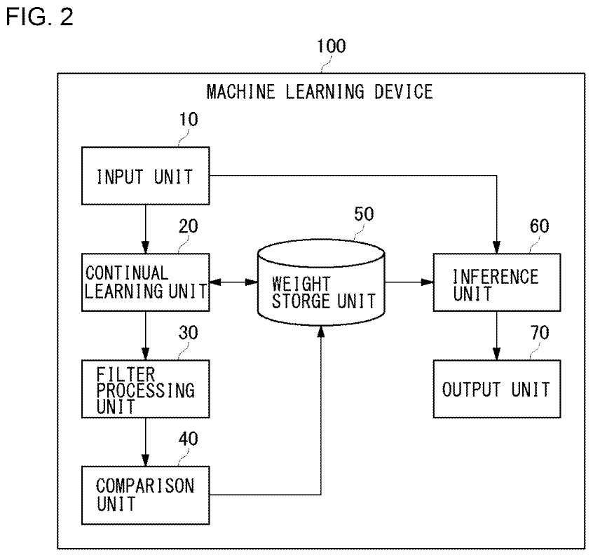

FIG. 2 shows a configuration of a machine learning device 100 according to the embodiment. The machine learning device 100 includes an input unit 10, a continual learning unit 20, a filter processing unit 30, a comparison unit 40, a weight storage unit 50, an inference unit 60, and an output unit 70.

The input unit 10 supplies a supervised task to the continual learning unit 20 and supplies an unknown task to the inference unit 60. By way of one example, the task is image recognition. The task is set to recognize a particular object. For example, task 1 is recognition of a cat, task 2 is recognition of a dog, etc.

The weight storage unit 50 stores the weights of multiple filters used to detect a feature of the task. By running an image through multiple filters, the feature of the image can be captured.

The continual learning unit 20 continually trains the weights of the multiple filters in the weight storage unit 50 in response to the input supervised task and saves the updated filter weights in the weight storage unit 50.

The filter processing unit 30 locks, of the multiple filters that have learned one task, the weights of a predetermined proportion of the filters to prevent them from being used to learn a further task and initializes the weights of the rest of the filters to use them to learn a further task. For example, the filters are arranged in the descending order of filter weight. The weights of 40% of the filters are locked in the descending order of weight value, and the weights of the remaining 60% of the filters are initialized to use them to learn a further task.

When the initialization by the filter processing unit 30 is completed, the comparison unit 40 compares the weights of multiples filters that have learned two or more tasks and extracts overlap filters for which a similarity in weight is equal to or greater than a threshold value as shared filters shared by tasks. The model is a multi-layer convolutional neural network so that a similarly between the weights of multiple filters are calculated in each layer. Of the overlap filters, the comparison unit 40 leaves one filter as a shared filter, initializes the weights of the filters other than the shared filter, and saves the weights in the weight storage unit 50.

The continual learning unit 20 continually trains the initialized weights of the filters other than the shared filter in response to a new task.

The inference unit 60 uses the filter weight saved in the weight storage unit 50 to infer from an input unknown task. The output unit 70 outputs a result of inference by the inference unit 60.

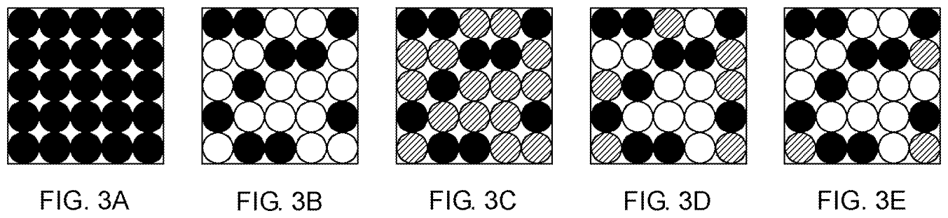

FIGS. 3A-3E show continual learning performed by the machine learning device 100 of FIG. 2. Multiple filters in each layer of a convolutional neural network are shown arranged in a lattice, where (i,j) denote a filter in the i-th row and the j-th column.

The learning process in the machine learning device 100 proceeds in the following steps (A)-(E).

(A) The model learns task 1. FIG. 3A shows an initial state of the filters that have learned task 1. All filters have learned task 1 and are shown in black.

(B) The filters are arranged in the descending order of weight value of the filter. The values of 60% of the entire filters are initialized in the ascending order of weight value. FIG. 3B shows a final state of the filters that have learned task 1. The initialized filters are shown in white.

(C) Task 2 is then learned. In this step, the weight values of the black filters of FIG. 3B are locked. The weight values of only the white filters can be changed. FIG. 3C shows an initial state of the filters that have learned task 2. All filters shown in white in FIG. 3B have learned task 2 and are shown in hatched lines in FIG. 3C.

(D) As in step (B), the hatched filters that have learned task 2 are arranged in the descending order of weight value of the filter. The values of 60% of the entire filters are initialized in the ascending order of weight value. FIG. 3D shows an intermediate state of the filters that have learned task 2. The initialized filters are shown in white.

(E) The weights are compared between the black filters that have learned task 1 and the hatched filters that have learned task 2. Those filters for which the similarity exceeds a predetermined threshold value are extracted as overlap filters. Referring to FIG. 3D, for example, the hatched filter (1,3) is similar to the black filter (1,2) so that these filters are determined to be overlap filters. Similarly, the hatched filter (3,1) and the black filter (3,2) are similar overlap filters, and the hatched filter (3,5) and the black filter (4,5) are similar overlap filters.

As shown in FIG. 3E, the hatched filter (1,3) can be substituted for by the similar black filter (1,2) for use so that the weight of the hatched filter (1,3) is initialized to turn it into a white filter, and the black filter (1,2) is defined as a shared filter shared by task 1 and task 2. Similarly, the hatched filter (3,1) is substituted for by the similar black filter (3,2) for use. The weight of the hatched filter (3,1) is initialized to turn it into a white filter. The black filter (3,2) is defined as a shared filter shared by task 1 and task 2. Further, the hatched filter (3,5) is substituted for by the similar black filter (4,5) for use. The weight of the hatched filter (3,5) is initialized to turn it into a white filter. The black filter (4,5) is defined as a shared filter shared by task 1 and task 2.

FIG. 3E shows a final state of the filters that have learned task 2. The initialized white filters are used to learn task 3, and the weights thereof are changed accordingly. Similarly, filters having a small weight value are initialized in the initial state of the filters that have learned task 3. The weights are compared between the filters that have learned task 3, the filters that have learned task 1, and the filters that have learned task 2. When there are overlap filters that have similarity, the filters for task 3 are initialized. This is repeated through task N.

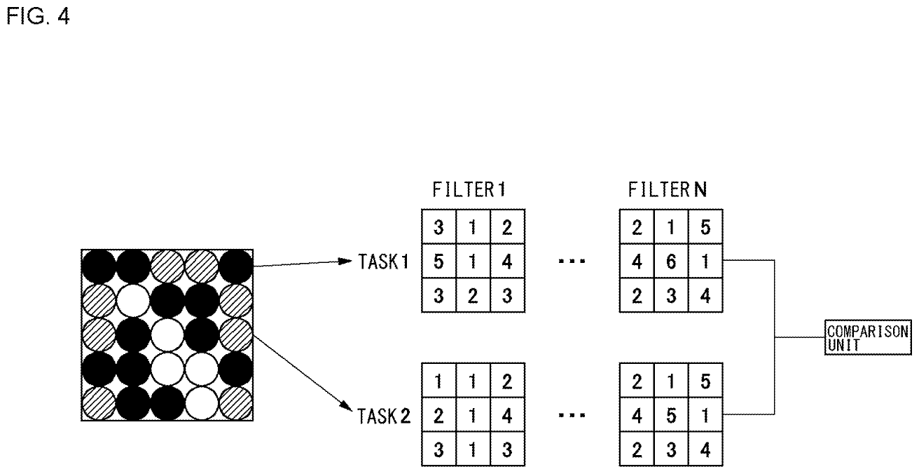

FIG. 4 shows an operation of the comparison unit 40 of the machine learning device 100 of FIG. 2.

In the intermediate state, shown in FIG. 3D, of the filters that have learned task 2, the weights of the filters that have learned task 1 and the weights of the filters that have learned task 2 are compared. Filters having a high similarity in weight are extracted and are defined as targets of initialization.

Since the model includes multiple layers, comparison is made in each layer. For example, one layer includes 128 filters. Given that there are 51 filters that have learned task 1 and 30 filters that have learned task 2, and the remaining filters are initialized, a similarity between the 51 filters for task 1 and the 30 filters for task 2 are calculated.

A similarity is calculated by comparing the absolute values of the filter weight values. In the case of 3×3 filters, for example, the absolute values of the nine weights are compared. A threshold value is defined. When the similarity exceeds the threshold value, it is determined that two filters overlap, and the weight of the filter for task 2 is initialized to 0.

Given that each component of filter A is defined by aᵢⱼ and each component of filter B is defined by bᵢⱼ, a difference in absolute value between the values at the same position in the two filters A, B is calculated as given by d₁(A,B), d₂(A,B), d=(A,B), and dₘ(A,B).

$${d}_{1} ( A , B ) = {\sum }_{i = 1}^{n} {\sum }_{j = 1}^{n} \vert {a}_{ij} - {b}_{ij} \vert$$

$${d}_{2} ( A , B ) = \sqrt{{\sum }_{i = 1}^{n} {\sum }_{j = 1}^{n} {( {a}_{ij} - {b}_{ij} )}^{2}}$$

$${d}_{∞} ( A , B ) = {max}_{1 \leq i \leq n} {max}_{1 \leq j \leq n} \vert {a}_{ij} - {b}_{ij} \vert$$

$${d}_{m} ( A , B ) = max ( ‖ ( A - B ) x ‖ : x ∈ , ‖ x ‖ = 1 )$$

In the above description, a similarly between filters is calculated by calculating a difference in absolute value between the values at the same position in the two filters. A similarly may be calculated by a method other than this. For example, a filter sum of absolute difference is defined for each filter as a sum of a horizontal sum of absolute difference SAD_H and a vertical sum of absolute difference SAD_V such that SAD=SAD_H+SAD_V. When a difference between the filter sum of absolute difference SAD_A of filter A and the filter sum of absolute difference SAD_B of filter B is smaller than a threshold value, it may be determined that filter A and filter B overlap. Given here that components of a 3×3 filter in the first row are a1, a2, a3, the components in the second row are a4, a5, a6, and the components in the third row are a7, a8, a9, the horizontal sum of absolute difference SAD_H and the vertical sum of absolute difference SAD_V are given by the following expression.

SAD_H=|a1-a2|+|a2-a3|+|a4-a5|+|a5-a6|+|a7-a8|+|a8-a9|

SAD_V=|a1-a4|+|a2-a5|+|a3-a6|+|a4-a7|+|a5-a8|+|a6-a9|

As an alternative method of calculating a similarity, comparison of a Euclid distance or a cosine distance may be used.

When filters have a high similarity in weight, the filters are determined to have identical of hardly different characteristics across tasks so that there is no need to maintain a filter that overlaps. Accordingly, one of such filters is initialized and used to learn a further task. The weight is defined as that of one component in a filter. In the case of the 3×3 filter of FIG. 4, the weight is defined as that of one cell in the matrix. Alternatively, the weight may be defined in units of filters, i.e., in units of matrices.

More generally speaking, when there is a filter that overlaps across task N and task N+1, the weight of the filter for task N+1 is initialized to 0 in order to maintain the performance at task N at the maximum level. This makes it possible to utilize limited filter resources maximally.

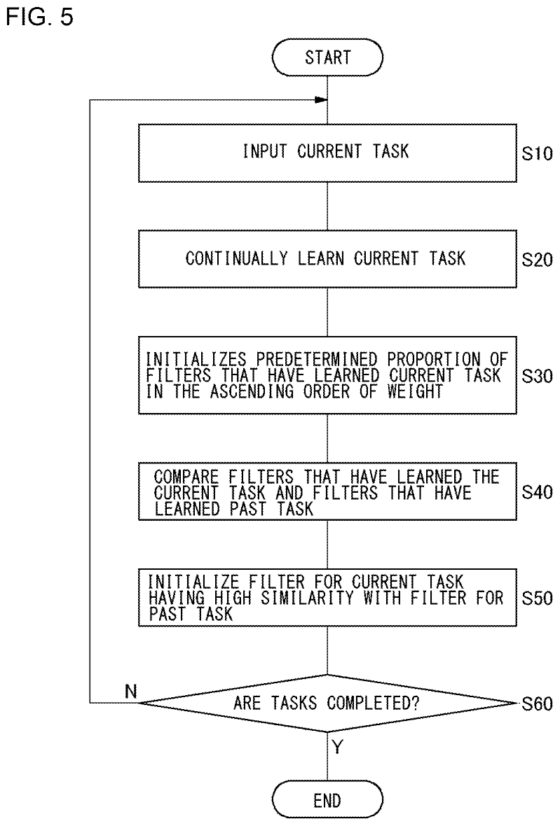

FIG. 5 is a flowchart showing a sequence of steps of continual learning performed by the machine learning device 100 of FIG. 2.

The input unit 10 inputs a current supervised task to the continual learning unit 20 (S10).

The continual learning unit 20 continually trains the weight of multiple filters in response a current task (S20).

The filter processing unit 30 initializes a predetermined proportion of the multiple filters that have learned the current task in the ascending order of weight value (S30).

The comparison unit 40 compares the filters that have learned the current task and the filters that have learned the past task and calculates a similarity in weight (S40).

The comparison unit 40 initializes the filter for the current task having a high similarity with the filter for the past task (S50).

When a task remains, control is returned to step S10, and the next task is input (N in S60). When the tasks have been completed, continual learning is terminated (Y in S60).

The above-described various processes in the machine learning device 100 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

As described above, the machine learning device 100 according to the embodiment makes it possible to mitigate the speed of saturation of filters in a continual learning model and to learn more tasks by using filters efficiently.

The present invention has been described above based on an embodiment. The embodiment is intended to be illustrative only and it will be understood by those skilled in the art that various modifications to combinations of constituting elements and processes are possible and that such modifications are also within the scope of the present invention.

What is claimed is:

1. A machine learning device comprising:
a weight storage unit that stores weights of a plurality of filters used to detect a feature of a task;
a continual learning unit that trains the weights of the plurality of filters in response to an input task in continual learning;
a filter processing unit that, of a plurality of filters that have learned one task, locks the weights of a predetermined proportion of the filters to prevent the predetermined proportion of the filters from being used to learn a further task and initializes the weights of other filters to use the other filters to learn a further task; and
a comparison unit that compares the weights of a plurality of filters that have learned two or more tasks and extracts overlap filters having a similarity in weight equal to or greater than a predetermined threshold value as shared filters shared by tasks.

2. The machine learning device according to claim 1, wherein
the comparison unit leaves one of the overlap filters as the shared filter and initializes the weights of filters other than the shared filter.

3. The machine learning device according to claim 2, wherein
the continual learning unit trains initialized weights of filters other than the shared filter in response to a further task in continual learning.

4. A machine learning method comprising:
training weights of a plurality of filters used to detect a feature of a task in response to an input task in continual learning;
of a plurality of filters that have learned one task, locking the weights of a predetermined proportion of the filters to prevent the predetermined proportion of the filters from being used to learn a further task and initializing the weights of other filters to use the other filters to learn a further task; and
comparing the weights of a plurality of filters that have learned two or more tasks, leaving one of overlap filters having a similarity in weight equal to or higher than a predetermined threshold value, and initializing the weights of other filters to use the other filters to learn a further task.

5. A non-transitory computer-readable recording medium having embodied thereon a machine learning program comprising computer-implemented modules including:
a module that trains weights of a plurality of filters used to detect a feature of a task in response to an input task in continual learning;
a module that, of a plurality of filters that have learned one task, locks the weights of a predetermined proportion of the filters to prevent the predetermined proportion of the filters from being used to learn a further task and initializes the weights of other filters to use the other filters to learn a further task; and
a module that compares the weights of a plurality of filters that have learned two or more tasks, leaves one of overlap filters having a similarity in weight equal to or higher than a predetermined threshold value, and initializes the weights of other filters to use the other filters to learn a further task.
